(19) United States
(12) Patent Application Publication
(10) Pub. No.: US 2003/0209472 A1
(43) Pub. Date: Nov. 13, 2003

(54) Magnetic sweeper

(76) Inventor: Chieh-Jen Hsiao, Taichung City (TW)

Correspondence Address: CHRISTIE, PARKER & HALE, LLP, 350 WEST COLORADO BOULEVARD, SUITE 500, PASADENA, CA, 91105, US

(21) Appl. No.: 10/142,385

(22) Filed: May 8, 2002

(51) Int. Cl. B03C 1/00

(52) U.S. Cl. 209/215; 209/229

(57) ABSTRACT

A magnetic sweeper includes a tubular body made of a non-magnetic material, a magnet unit, and a slider made of a non-magnetic material. The magnet unit is disposed inside the tubular body, and is capable of attracting and retaining magnetically attractable pieces on an attracting portion of the tubular body. The slider is mounted on and is slidable along the tubular body such that movement of the slider on the tubular body can result in pushing of the magnetically attractable pieces out of the magnetic range of the magnet unit such that the magnetically attractable pieces can fall freely from the tubular body.

### BACKGROUND OF THE INVENTION

1. Field of the Invention

The invention relates to a magnetic sweeper, more particularly to a magnetic sweeper that is convenient to use.

2. Description of the Related Art

Referring to FIGS. 1 and 2, a conventional magnetic sweeper, as disclosed in U.S. Pat. No. 5,285,904, is shown to comprise an elongated hollow body member 1, a magnet unit 2 disposed in the body member 1, two wheels 3 mounted respectively on opposite ends of the body member 1, a handle member 4 disposed centrally between the ends of the body member 1 for moving the magnetic sweeper over a floor surface, and a catcher member 5 removably mounted on the body member 1. In use, the body member 1 is rolled across a floor surface via the handle 4. Metallic objects 6, such as nails, screws and nuts, are picked up, and are magnetically held against the surface area of the catcher member 5. When the sweeping operation is completed, the catcher member 5 is pulled so as to be separate from the body member 1 such that the metallic objects 6 can fall off from the catcher member 5 and into a receptacle for collection since the objects 6 are no longer in the magnetic range of the magnet unit 2. The catcher member 5 is then reinstalled on the body member 1 for subsequent use.

The following are some of the drawbacks of the conventional magnetic sweeper:

1. Repeated engagement and disengagement of the catcher member 5 with the body member 1 is required, thereby rendering the conventional magnetic sweeper inconvenient to use.

2. Hand injury is likely to occur during removal of the catcher member 5 from the body member 1.

3. The catcher member 5 has to cover the entire length of the body member 1, thereby increasing not only the weight of the magnetic sweeper, but also the cost of material.

### SUMMARY OF THE INVENTION

Therefore, the main object of the present invention is to provide a magnetic sweeper that is convenient and safe to use and that can reduce the cost of material.

According to the present invention, a magnetic sweeper comprises a tubular body, a magnet unit, and a slider. The tubular body is made of a non-magnetic material. The magnet unit is disposed inside the tubular body such that the tubular body is configured with an attracting portion and a releasing portion, and is capable of attracting and retaining magnetically attractable pieces on the attracting portion. The slider is made of a non-magnetic material, and is mounted on and is slidable along the tubular body such that movement of the slider on the tubular body can result in pushing of the magnetically attractable pieces from the attracting portion to the releasing portion so as to be disposed out of the magnetic range of the magnet unit such that the magnetically attractable pieces can fall freely from the tubular body.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary partly exploded perspective view of the conventional magnetic sweeper;

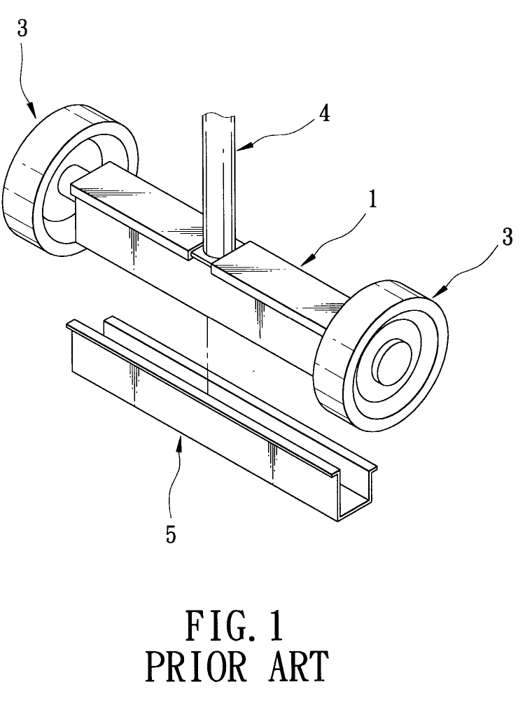

FIG. 2 is an enlarged cross sectional view of the magnetic sweeper of FIG. 1;

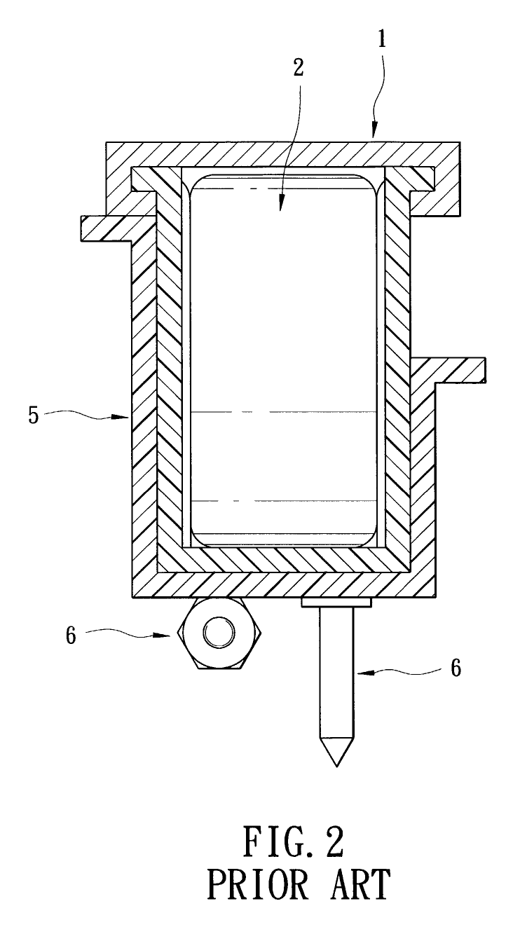

FIG. 3 is a fragmentary exploded perspective view of the first preferred embodiment of a magnetic sweeper according to the present invention;

FIG. 4 is a fragmentary assembled cross-sectional view of the first preferred embodiment;

FIG. 5 is another fragmentary assembled sectional view, illustrating the first preferred embodiment in a state of use; and

FIG. 6 is a fragmentary assembled sectional view of the second preferred embodiment of a magnetic sweeper according to the present invention.

### DETAILED DESCRIPTION OF THE PREFERRED EMBODIMENTS

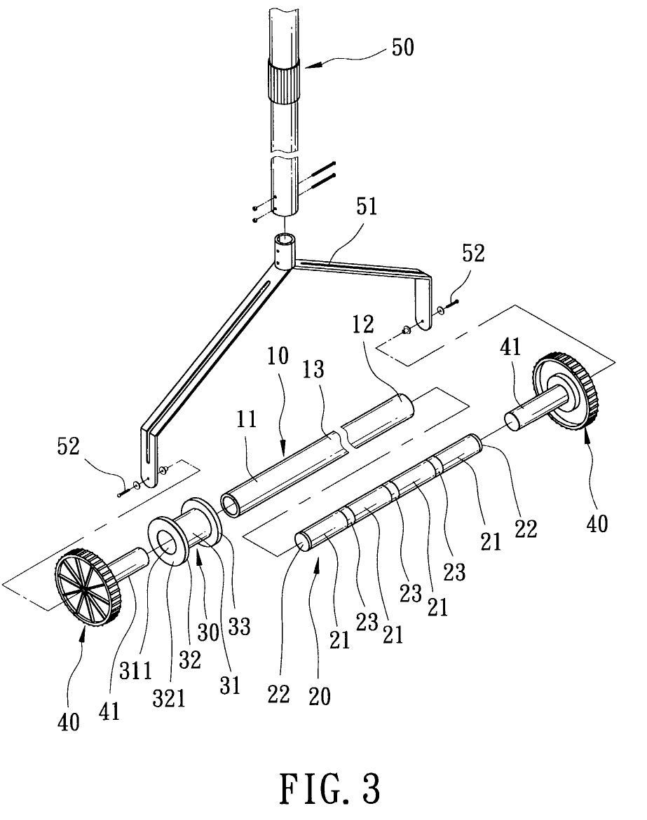

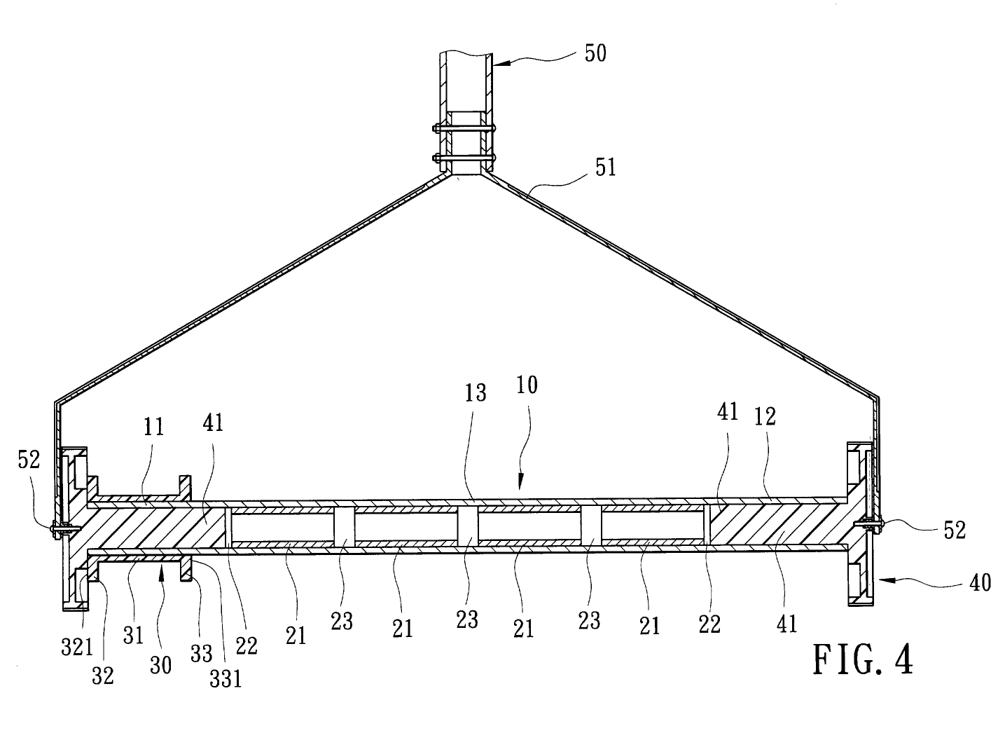

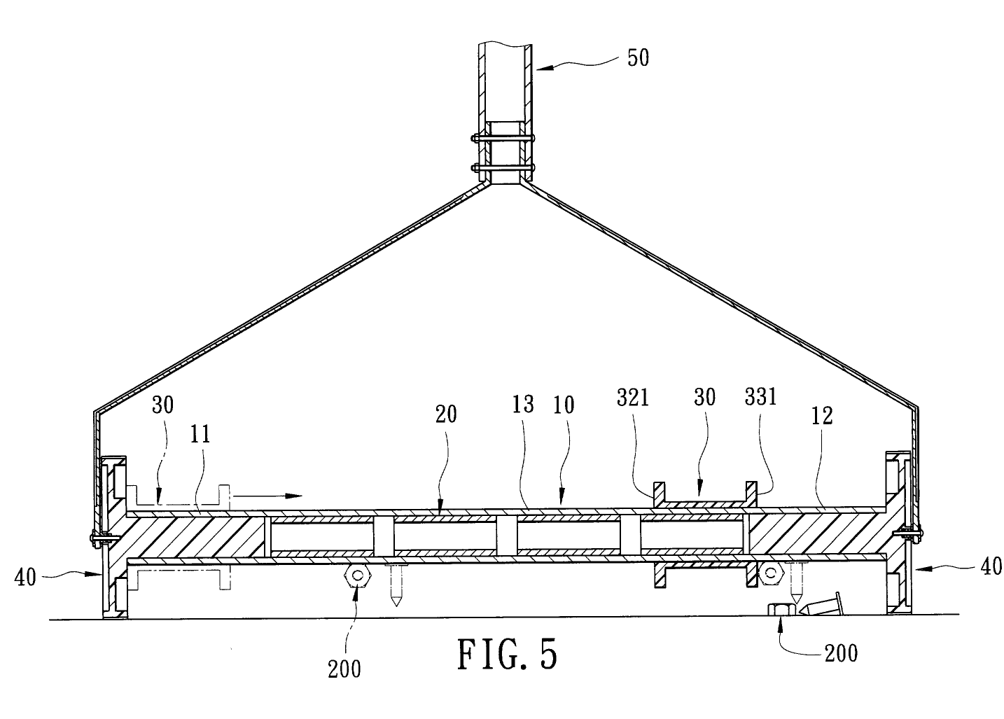

Referring to FIGS. 3 to 5, the first preferred embodiment of a magnetic sweeper according to the present invention is shown to comprise a tubular body 10, a magnetic unit 20, a slider 30, a pair of wheels 40, and a handle unit 50.

The tubular body 10 is made of a non-magnetic material. In this embodiment, the tubular body 10 is a cylindrical tube made of iron, and has a first end portion 11, a second end portion 12 opposite to the first end portion 11, and an intermediate portion 13 between the first and second end portions 11, 12.

The magnet unit 20 is disposed inside the tubular body 10 such that the tubular body 10 is configured with an attracting portion and a releasing portion, and is capable of attracting and retaining magnetically attractable pieces 200, such as nails, screws and nuts, on the attracting portion. The magnet unit 20 in this embodiment includes three permanent magnets 23, four iron tubes 21, and two round iron end pieces 22. Each magnet 23 is clamped between a pair of iron tubes 21 that are in axial alignment. The end pieces 22 are magnetically attached to opposite outermost ends of the iron tubes 21. The assembled magnet unit 20 is then disposed in the intermediate portion 13 of the tubular body 10 such that the intermediate portion 13 of the tubular body 10 serves as the attracting portion, and such that the first and second end portions 11, 12 of the tubular body 10 serve as the releasing portion.

The slider 30 is made of a non-magnetic material. In this embodiment, the slider 30 is formed as a plastic tube, and is mounted on and is slidable along the tubular body 10. The slider 30 includes a peripheral wall 31 that is disposed to surround an axis of the tubular body 10 so as to define an axial hole 311, and first and second flanges 32, 33. Each of the first and second flanges 32, 33 extends outwardly from a respective peripheral end of the peripheral wall 31, and has a flange end face 321, 331. The slider 30 is shorter than the first and second end portions 11, 12 of the tubular body 10 such that movement of the slider 30 on the tubular body 10 can result in pushing of the magnetically attractable pieces 200 by a respective flange end face 321, 331 of the slider 30 from the attracting portion to the releasing portion of the tubular body 10. As such, the magnetically attractable pieces 200 can be disposed out of the magnetic range of the magnet unit 20 so as to fall freely from the tubular body 10.

Each of the wheels 40 includes an axle 41 that is inserted securely into a respective one of the first and second end portions 11, 12 of the tubular body 10 to permit movement of the tubular body 10 on a ground surface. Each axle 41 has a length equal to that of the first and second end portions 11, 12 of the tubular body 10. The handle unit 50 is telescopic, and is operatively coupled to the tubular body 10 for moving the latter over a surface to be swept of the magnetically attractive pieces 200. In this embodiment, the handle unit 50 includes a forked end 51 with two prongs, each of which is connected to a respective one of the first and second end portions 11, 12 of the tubular body 10 via a respective one of the wheels 40 by means of a screw bolt 52.

In use, the tubular body 10 is rolled across a floor surface. The magnetically attractable pieces 200 are picked up, and are magnetically held against the surface area of the intermediate portion 13 of the tubular body 10. When the sweeping operation is completed, the slider 30 is moved slidably along the tubular body 10 such that the flange end face 331 of the second flange 33 pushes the magnetically attractable pieces 200 from the intermediate portion 13 toward the second end portion 12 of the tubular body 10. At this time, since the magnetically attractable pieces 200 are disposed out of the magnetic range of the magnet unit 20, the magnetically attractable pieces 200 can fall freely from the second end portion 12 of the tubular body 10 to a receptacle (not shown) for collection. The magnetic sweeper of the present invention is thus ready for a subsequent sweeping operation. This time, after the sweeping operation is completed, the slider 30 is moved such that the flange end face 321 of the first flange 32 pushes the magnetically attractable pieces 200 from the intermediate portion 13 toward the first end portion 11 of the tubular body 10, thereby disposing the magnetically attractable pieces 200 out of the magnetic range of the magnet unit 20. As such, the magnetically attractable pieces 200 can fall freely from the first end portion 11 of the tubular body 10 to the receptacle for collection.

The advantages of the magnetic sweeper of the present invention can be summarized as follows:

1. The magnetically attractable pieces 200 are removed from the intermediate portion 13 of the tubular body 10 by simply moving the slider 30 from the first to the second end portion 11, 12 of the tubular body 10 and vice versa, thereby speeding up the subsequent use of the magnetic sweeper. Thus, the magnetic sweeper is simple and convenient to use.

2. Since removal of the magnetically attractable pieces 200 is done by pushing the slider 30 along the tubular body 10, hand injury can be prevented.

3. Since the slider 30 is shorter than the tubular body 10, weight and material cost of the magnetic sweeper can be reduced.

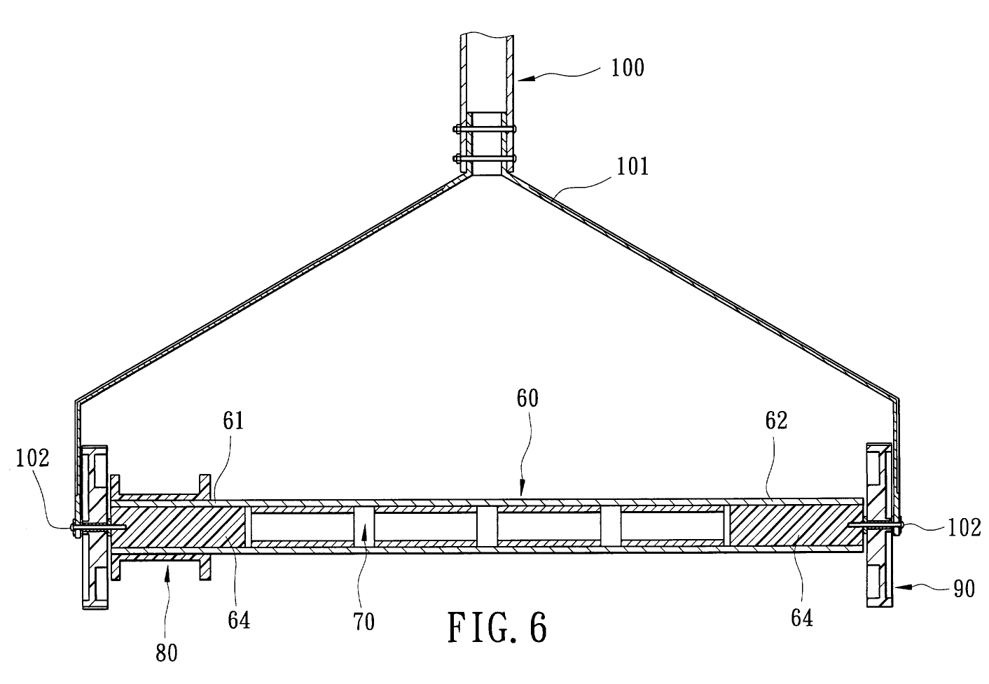

Referring to FIG. 6, the second preferred embodiment of a magnetic sweeper according to the present invention is shown to be substantially similar to the first preferred embodiment. However, in this embodiment, the first and second end portions 61, 62 of a tubular body 60 are inserted respectively with a plastic piece 64 instead of axles of the wheels 90. Each of the wheels 90 is connected to a forked end 101 of the handle unit 100 and a respective one of the first and second end portions 61, 62 of the tubular body 60 by means of a screw bolt 102 that passes through the forked end 101, extends through the respective wheel 90, and engages the plastic piece 64 in the respective one of the first and second end portions 61, 62 of the tubular body 60. The advantages of the first preferred embodiment can be similarly attained using the second preferred embodiment.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A magnetic sweeper comprising:
a tubular body made of a non-magnetic material;
a magnet unit disposed inside said tubular body such that said tubular body is configured with an attracting portion and a releasing portion, said magnet unit being capable of attracting and retaining magnetically attractable pieces on said attracting portion; and
a slider made of a non-magnetic material, said slider being mounted on and being slidable along said tubular body such that movement of said slider on said tubular body can result in pushing of the magnetically attractable pieces from said attracting portion to said releasing portion so as to be disposed out of the magnetic range of said magnet unit such that the magnetically attractable pieces can fall freely from said tubular body.

2. The magnetic sweeper as claimed in claim 1, wherein:
said tubular body has a first end portion, a second end portion opposite to said first end portion, and an intermediate portion between said first and second end portions;
said magnet unit being disposed in said intermediate portion of said tubular body such that said intermediate portion of said tubular body serves as said attracting portion, and such that said first and second end portions of said tubular body serve as said releasing portion.

3. The magnetic sweeper as claimed in claim 1, further comprising wheel means mounted on said tubular body for movement of said tubular body on a ground surface.

4. The magnetic sweeper as claimed in claim 2, further comprising a pair of wheels, each of which is mounted on a respective one of said first and second end portions of said tubular body.

5. The magnetic sweeper as claimed in claim 2, wherein said slider is shorter than said first and second end portions of said tubular body.

6. The magnetic sweeper as claimed in claim 1, wherein said magnet unit includes at least a permanent magnet.

7. The magnetic sweeper as claimed in claim 3, further comprising a handle unit operatively coupled to said tubular body for moving said tubular body over a surface to be swept of the magnetically attractive pieces.

8. The magnetic sweeper as claimed in claim 2, further comprising a handle unit that has a forked end coupled to said first and second end portions of said tubular body.
